(19) United States
(12) Patent Application Publication
(10) Pub. No.: US 2011/0168899 A1
(43) Pub. Date: Jul. 14, 2011

(54) DETECTOR ASSEMBLIES AND SYSTEMS HAVING MODULAR HOUSING CONFIGURATION

(76) Inventors: Andrew Cheshire, Burlington, KY (US); Craig A. Caris, Dry Ridge, KY (US)

(21) Appl. No.: 12/686,522

(22) Filed: Jan. 13, 2010

(51) Int. Cl. G01F 23/288

(52) U.S. Cl. 250/357.1

(57) ABSTRACT

A detector assembly includes an elongate structure and a scintillation detector. The elongate structure defines a detector cavity having an axial dimension extending along a longitudinal axis. The scintillation detector is disposed at least partially within the detector cavity. The detector system can also include a cabinet which can be coupled with an end of the elongate structure, and which can define a cabinet cavity for retaining a junction board, a display screen, a microprocessor unit, and/or other components. The detector assembly can have an explosion-proof rating. A detector system including the detector assembly and a detector unit is also provided, such as for use in applications requiring an explosion-proof rating.

### TECHNICAL FIELD

The present invention relates to detector assemblies and systems which have a modular housing configuration.

### BACKGROUND

Conventional detector systems are provided to measure a variety of process and material characteristics such as, for example, the level or density of fluid within a tank or pipe. A Cesium¹³⁷ radiation source emits gamma energy which passes through a tank or pipe and then impacts a detector. Impact of the gamma energy upon the detector results in scintillations of light within the detector, which are measured and evaluated to determine fluid level and/or density within the tank or pipe. Examples of certain conventional detector systems are shown in FIGS. 23-25.

### SUMMARY

In accordance with one embodiment, a detector assembly comprises an elongate structure, a cabinet, a scintillation detector, and a wire harness. The elongate structure has a proximal end and a distal end and defines a detector cavity. The detector cavity has an axial dimension extending along a longitudinal axis. The detector cavity also has a first transverse cross-sectional shape. The cabinet is attached to the proximal end of the elongate structure. The cabinet defines a cabinet cavity in communication with the detector cavity. The cabinet cavity extends along the longitudinal axis and has a second transverse cross-sectional shape which is greater than the first transverse cross-sectional shape. The scintillation detector is disposed within at least one of the detector cavity and the cabinet cavity. The wire harness is coupled with the scintillation detector and extends into the cabinet cavity.

In accordance with another embodiment, a detector system comprises a detector assembly and a rigid crystal-type detection unit. The detector assembly comprises an elongate structure, a scintillation detector, an end wall, and a light pipe. The elongate structure has a proximal end and a distal end and defines a detector cavity. The detector cavity has an axial dimension extending along a longitudinal axis. The scintillation detector is disposed at least partially within the detector cavity. The end wall is attached to the distal end of the elongate structure. The end wall defines an aperture extending through the end wall. The light pipe extends into the aperture in the end wall and is in optical communication with the scintillation detector. The rigid crystal-type detection unit is separable from the detector assembly and comprises a protective sheath and a rigid crystal. The protective sheath has a first end and a second end and defines a sheath cavity extending along the longitudinal axis. The rigid crystal extends along the longitudinal axis and is disposed within the sheath cavity. The first end of the protective sheath is removably fastened to the end wall. The rigid crystal is in optical communication with the light pipe.

In accordance with yet another embodiment, a detector assembly comprises an elongate structure, a scintillation detector, an end wall, and a light pipe. The elongate structure has a proximal end and a distal end and defines a detector cavity. The scintillation detector is disposed at least partially within the detector cavity. The end wall is attached to the distal end of the elongate structure and defines an aperture extending through the end wall. The light pipe extends into the aperture in the end wall and is in optical communication with the scintillation detector. Each of the end wall and the light pipe are configured to selectively and alternatively couple with a rigid crystal-type detection unit and a flexible fluid-type detection unit.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a front elevational view depicting a detector assembly in accordance with one embodiment;

FIG. 2 is a rear elevational view depicting the detector assembly of FIG. 1;

FIG. 3 is a bottom side perspective view depicting the detector assembly of FIG. 1;

FIG. 4 is a top plan view depicting the detector assembly of FIG. 1;

FIG. 5 is a top perspective view depicting a portion of the detector assembly of FIG. 1, wherein certain bolts have been removed from a cabinet, a lid of the cabinet is opened with respect to a base of the cabinet, and a processor unit is in a seated position;

FIG. 6 is a top perspective view depicting the portion of the detector assembly of FIG. 5, wherein certain additional bolts are removed, and wherein the processor unit is in an unseated position to reveal a junction board;

FIG. 7 is a cross-sectional view depicting the cabinet and components within the cabinet of the detector assembly of FIG. 1, wherein other portions of the detector assembly are not shown;

FIG. 8 is a partially exploded perspective view depicting the detector assembly of FIG. 1;

FIG. 9 is a front elevational view depicting the detector assembly of FIG. 1, wherein certain portions of the detector assembly are shown in fragment or cross-section;

FIG. 10 is a perspective view depicting a portion of the detector assembly of FIG. 1 apart from the remainder of the detector assembly of FIG. 1;

FIG. 11 is a rear plan view depicting an end wall of FIG. 10 apart from the remaining components of FIG. 10;

FIG. 12 is a front plan view depicting the end wall of FIG. 11;

FIG. 13 is a partially exploded cross-sectional view depicting the portion of the detector assembly of FIG. 10;

FIG. 14 is a cross-sectional view depicting the portion of the detector assembly of FIG. 10;

FIG. 15 is a front elevational view depicting a detector system including the detector assembly of FIG. 1 attached to a rigid crystal-type detection unit, wherein a portion of the rigid crystal-type detection unit is shown in cross-section, and wherein a hidden portion of the detector assembly is shown in dashed lines;

FIG. 16 is a front elevational view depicting a detector system including the detector assembly of FIG. 1 attached to a flexible fluid-type detection unit, wherein a portion of the flexible fluid-type detection unit is shown in cross-section, and wherein a hidden portion of the detector assembly is shown in dashed lines;

FIG. 17 is a side elevational view depicting a detector system in association with a pipe, a bracket assembly, a radiation source, and a shield, wherein the detector system is similar to that of FIG. 15;

FIG. 18 is a top plan view, partially in cross-section, depicting the components of FIG. 17;

FIG. 19 is a side elevational view, partially in cross-section, depicting the detector system of FIG. 16 in association with a tank and a radiation source;

FIG. 20 is a side elevational view, partially in cross-section, depicting the cabinet removed from the other components of the detector assembly of FIG. 1 and in association with a pipe plug;

FIG. 21 is a schematic diagram depicting electrical coupling of certain components of the detector assembly of FIG. 1, and of the detector assembly with a remote monitoring facility;

FIG. 22 is a partially exploded perspective view depicting a detector assembly in accordance with another embodiment;

FIG. 23 is a perspective view depicting a conventional detector system;

FIG. 24 is a front elevational view, partially in cross-section, depicting a portion of the conventional detector system of FIGS. 23; and

FIG. 25 is a cross-sectional view depicting a portion of another conventional detector system.

### DETAILED DESCRIPTION

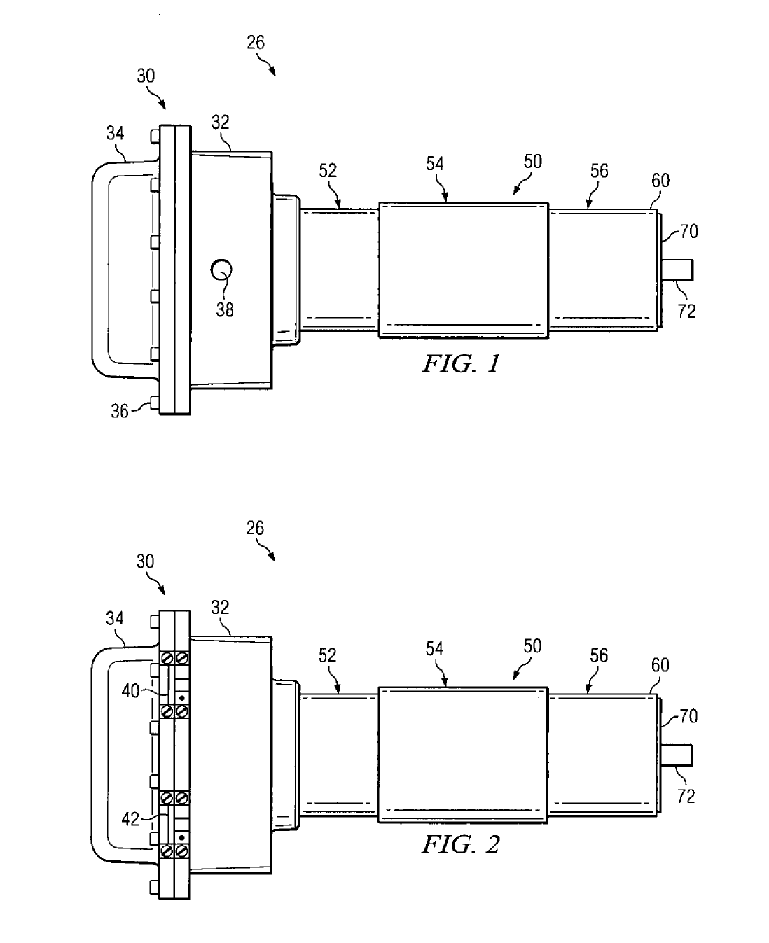

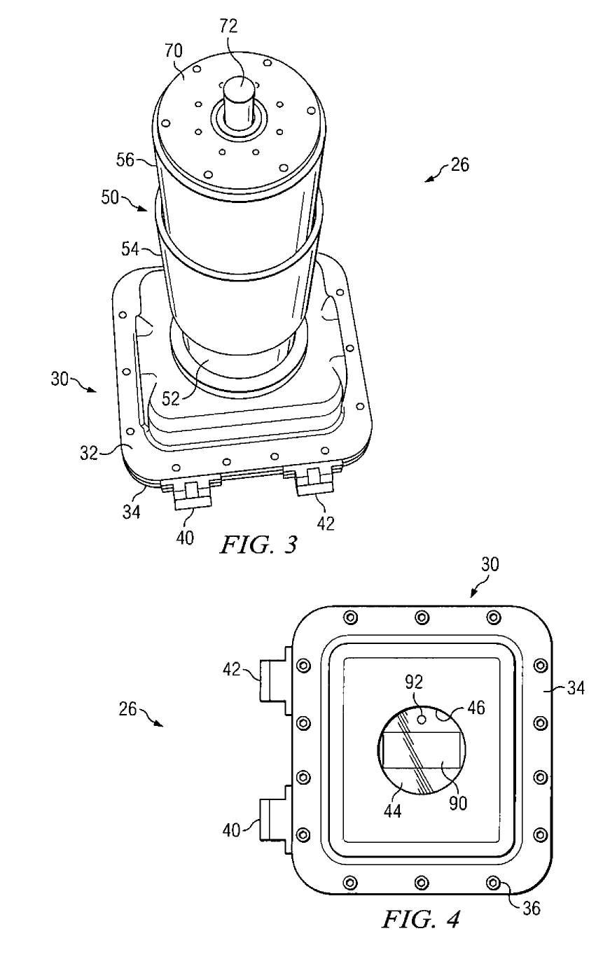

Certain embodiments are hereinafter described in detail in connection with the views and examples of FIGS. 1-22, wherein like numbers illustrate like elements throughout the views. A detector system can be provided to measure any of a variety of process or material characteristics such as, for example, the level or density of fluid within a tank or pipe. The detector system can include a detector assembly and a detection unit. A radiation source can emit energy which passes through the tank or pipe and then impacts the detection unit. Fluid level and/or density can be determined by monitoring the manner in which the energy from the radiation source passes through the fluid and impacts the detection unit. More particularly, upon impact of the energy with the detection unit, scintillations of light can occur within the detection unit and can be channeled through the detection unit to the detector assembly. The detector assembly can include a scintillation detector which can detect the scintillations and provide corresponding data to a processor unit. The processor unit can process this data to determine characteristics of the fluid through which the energy has passed, and can facilitate display or transmission of data or signals identifying the determined characteristics. Such characteristics can include, for example, fluid level and/or fluid density.

Detector systems can be provided in industrial or commercial applications where flammable or combustible materials are present. Accordingly, the detector systems can be required to have an explosion-proof rating or construction. By providing a detector system which is explosion-proof; it will be appreciated that the various components of the detector system can be capable of withstanding an internal explosion without allowing hot gases or flames to escape from the various components which would otherwise possibly trigger an explosion in the surrounding atmosphere. “Explosion-proof” is a term used by national rating agencies such as Underwriters Laboratories and Factory Mutual Research in order to indicate their certification that a component has met their specifications and passed their tests. For a device to be explosion-proof, it typically must be provided with a sturdy and thick-walled housing.

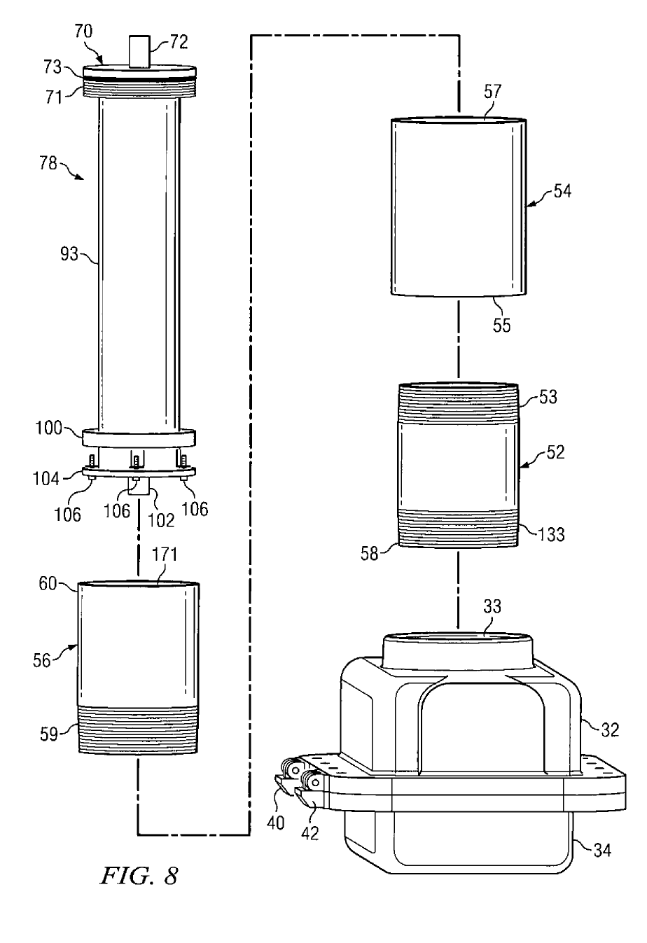

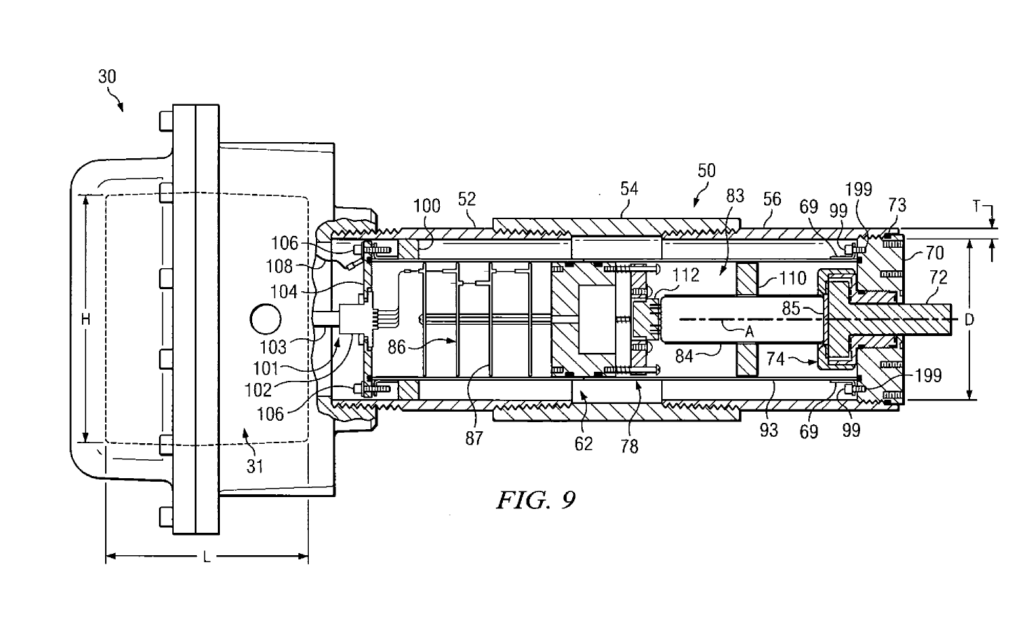

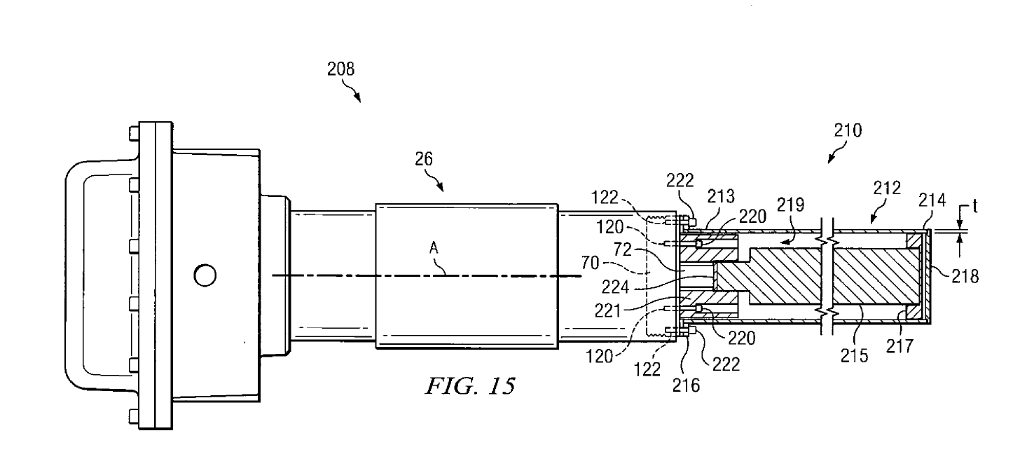

A detector assembly 26 will now be described with reference to FIGS. 1-19 and 21, and can serve as an explosion-proof component of a modular detector system in any of a variety of suitable applications. As will be described in detail below, the detector assembly 26 can be removably attached to a detection unit (e.g., 210, 310, see FIGS. 15-19), and can include a scintillation detector 78 (FIGS. 8-9) which is configured to detect scintillations within the detection unit. The detector assembly 26 can also include a processor unit 88 which can receive and process signals from the scintillation detector 78 such as for local and/or remote display (e.g., upon a display screen 90). FIG. 21 generally illustrates an example of how certain components of the detector assembly 26 can be electrically coupled, and the manner in which electrical signals and data can flow among them, such as in response to detection by the scintillation detector 78 of scintillations occurring within an associated detection unit (e.g., 210, 310, see FIGS. 15-19).

The detector assembly 26 can have an explosion-proof housing which serves to enclose one or more internal components. The explosion-proof housing is generally shown to include a cabinet 30, an elongate structure 50, an end wall 70, and a light pipe 72. The cabinet 30 can include one or more ports (e.g., 38 in FIG. 1) which can be threaded to receive conduit or other fitting to facilitate passage of field wiring (e.g., 192 in FIG. 21) into the detector assembly 26. The field wiring can provide power to the detector assembly 26 and/or can facilitate transmission of fluid level or density or other signals from the detector assembly 26 such as to a remote monitoring facility (e.g., 190 in FIG. 21). A port (e.g., 38) which does not receive a conduit or other fitting can receive a pipe plug to close and seal the port. While the cabinet 30 of the detector assembly 26 is shown to include only a single port (i.e., 38), it will be appreciated that the cabinet 30 can alternatively be provided with multiple respective ports, such as for receiving respective conduits or other fittings.

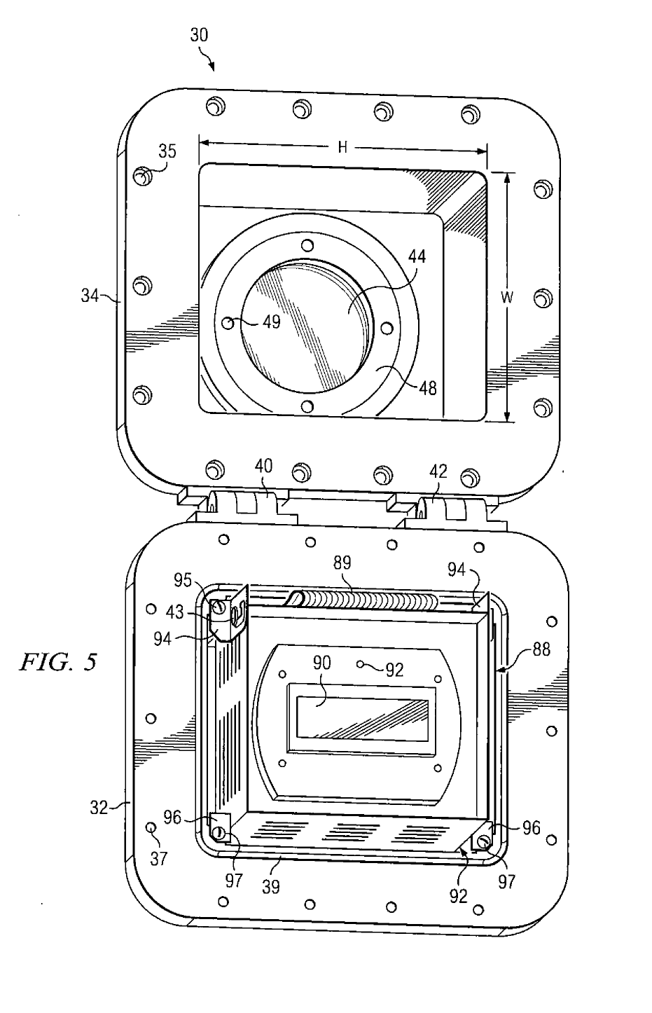

The cabinet 30 is shown in FIGS. 1-9 to comprise a base 32, a lid 34, hinges 40 and 42, and a plurality of fasteners (e.g., bolt 36). The lid 34 can be hingedly coupled with the base 32 by way of the hinges 40 and 42 such that the lid 34 can pivot with respect to the base 32 between closed and opened positions (shown in FIGS. 1 and 5, respectively). When the lid 34 is in the closed position, the fasteners (e.g., bolt 36) can be inserted through unthreaded apertures (e.g., 35) in the lid 34 and tightened into threaded apertures (e.g., 37) in the base 32. In an alternative embodiment, fasteners (e.g., bolts) can additionally or alternatively be inserted through unthreaded apertures in the base of a cabinet, and tightened into threaded apertures in the lid of the cabinet. A seal member 39 can be provided in a channel defined in the base 32 to facilitate a sealed interface between the base 32 and the lid 34 when the lid 34 is in the closed position and when the fasteners (e.g., bolt 36) are inserted and tightened. In an alternative embodiment, such a seal member can alternatively or additionally be provided in a channel defined in the lid of a cabinet.

The fasteners (e.g., bolt 36) can be configured to selectively secure the base 32 to the lid 34 in a closed position such that the base 32 and the lid 34 cooperate to define a cabinet cavity 31. The cabinet cavity 31 can have an axial dimension (“L” in FIG. 9) extending along a longitudinal axis (“A” in FIG. 9) and can have a transverse cross-sectional shape which is shown to be generally rectangular and to have a height (“H” in FIG. 5) and a width (“W” in FIG. 5). In one embodiment, as generally shown with respect to the cabinet cavity 31, the transverse cross-sectional shape of the cabinet cavity 31 can be generally uniform along substantially the entire axial dimension “L” of the cabinet cavity 31.

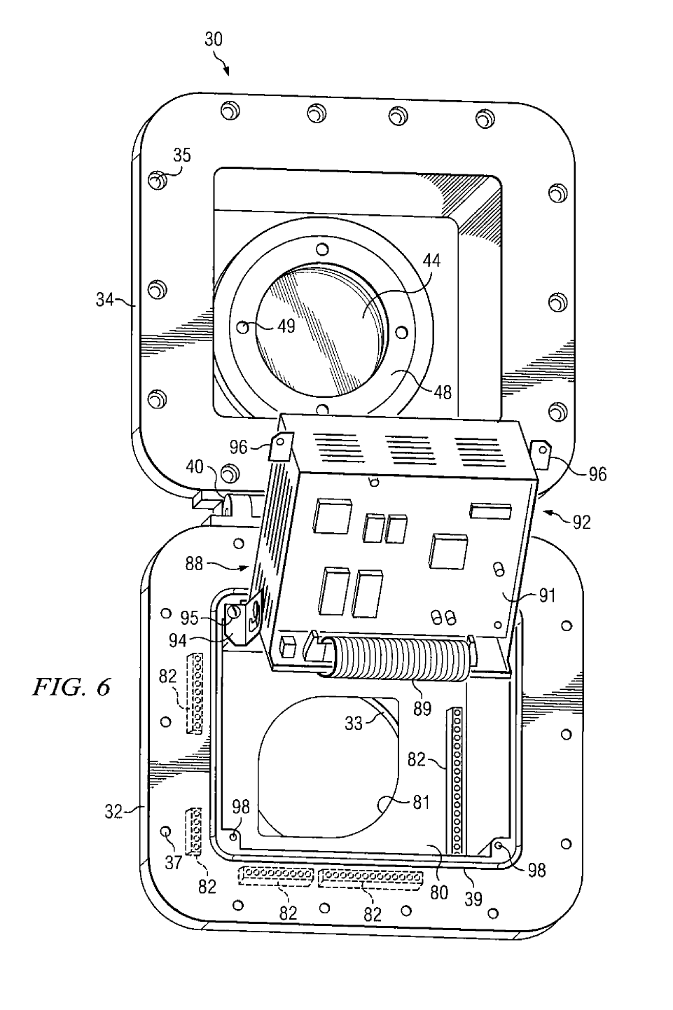

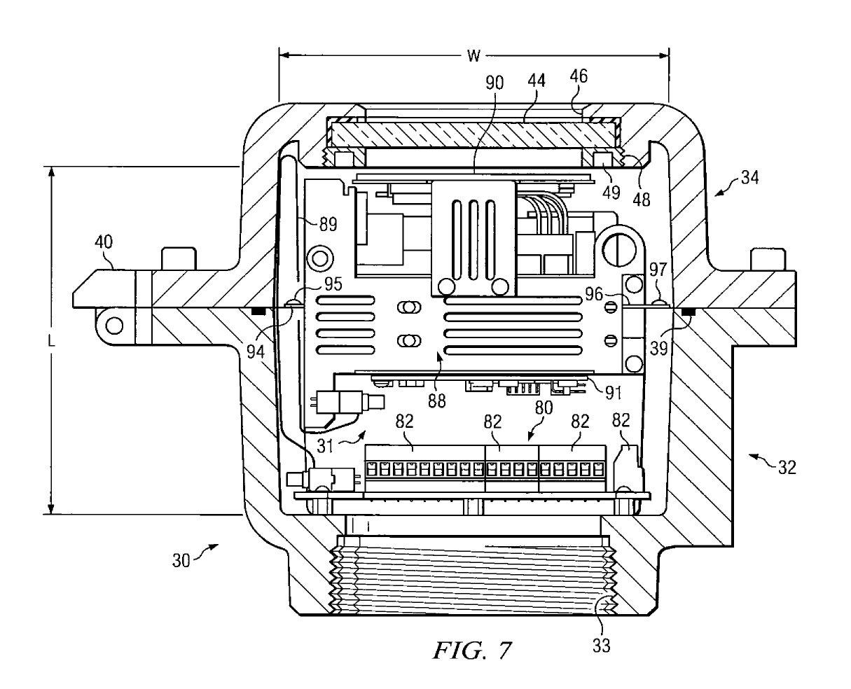

The detector assembly 26 can include a junction board 80 which can be attached (e.g., with bolts) to the base 32 within the cabinet cavity 31, as shown in FIGS. 6-7. The junction board 80 can include terminal strips 82 which can be configured for coupling with field wiring (e.g., 192 in FIG. 21) and/or to a wire harness 101 (FIG. 9) leading to the scintillation detector 78. In one embodiment, the junction board 80 can define an aperture 81 (FIG. 6) which can facilitate passage of the wire harness 101 to the scintillation detector 78. The junction board 80 can also receive a ribbon cable 89 which leads to the processor unit 88, as shown in FIG. 7.

The processor unit 88 can be moveably coupled with the base 32 such that the processor unit 88 can be selectively repositioned between seated and unseated positions, as respectively shown in FIGS. 5 and 6. In particular, flanges 94 can be attached to the base 32 with bolts 95 (one shown) and can each define a slot or aperture which rotatably or moveably receives a portion (e.g., a pin 43 in FIG. 5) of the processor unit 88, such that the processor unit 88 can be pivotable or otherwise moveable between the seated and unseated positions. The processor unit 88 can include flanges 96 which can be secured to the base 32 by inserting bolts 97 through the respective flanges 96 and into respective threaded apertures 98 in the base 32, in order to secure the processor unit 88 in the seated position, as shown in FIG. 5. Upon removal of the bolts 97, the processor unit 88 can be moved to the unseated position, as shown in FIG. 6, such as to facilitate access to the junction board 80 for connection of field wiring.

The processor unit 88 can include one or more circuit boards (e.g., 91 in FIG. 6) which can include analog and/or digital components. The processor unit 88 can be configured to receive electrical signals from the scintillation detector 78 via the junction board 80 (see FIG. 21). In one embodiment, electrical signals from the scintillation detector 78 can pass to the processor unit 88 sequentially through the wire harness 101, the junction board 80, and the ribbon cable 89. However, it will be appreciated that electrical signals can be transmitted among various components of a detector assembly in any of a variety of other suitable configurations. With reference to FIG. 9, the wire harness 101 can include a connector 102 attached to the scintillation detector 78 as well as a mating connector 103 from which wires (not shown) can extend to the junction board 80. In an alternative embodiment, a scintillation detector might not include such connectors, and a wire harness might instead include wires which extend directly from a scintillation detector to a junction board and/or a processor unit.

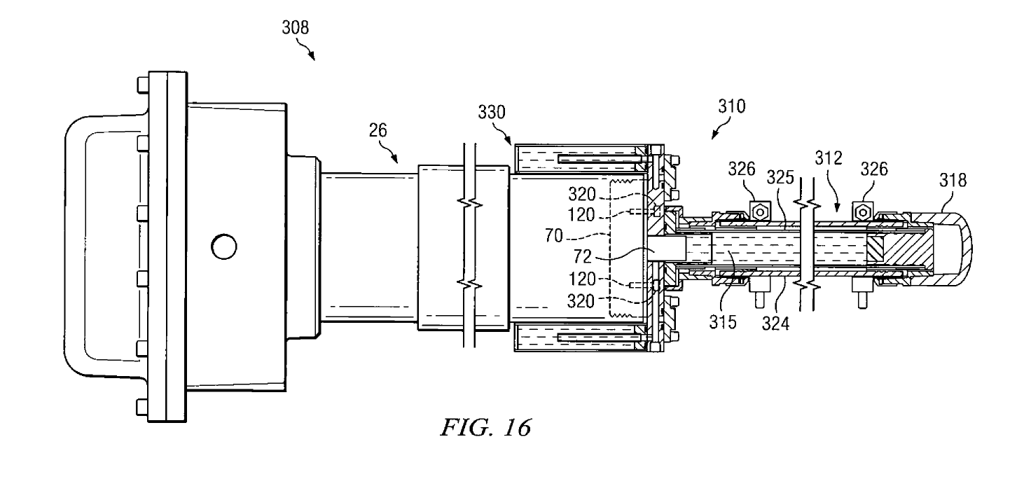

The scintillation detector 78 can generate signals in response to its detection of scintillations within an associated detection unit (e.g., 210 in FIG. 15, 310 in FIG. 16), and the wire harness 101 can facilitate transmission of those signals to the processor unit 88 (e.g., via the junction board 80 and the ribbon cable 89). In response to these signals from the scintillation detector 78, the processor unit 88 can be configured to generate a feedback signal such as can indicate fluid level and/or fluid density. The feedback signal can be provided from the processor unit 88 to the junction board 80 by way of the ribbon cable 89. The feedback signal can then be provided to field wiring (e.g., 192 in FIG. 21) attached to the terminal strips 82, such as for transmission away from the detector assembly 26 and over an extended distance, such as through conduit, to a remote monitoring facility (e.g., 190 in FIG. 21).

The feedback signal can be of a type which is readily understood by conventional monitoring facilities such as programmable logic controllers, display units, or otherwise. A feedback signal can provide analog information (e.g., density or level) in any of a variety of analog formats such as 0-10 volts, 4-20 milliamperes, and/or in any of a variety of digital formats to accommodate a particular communication protocol such as, for example, Pro fibus, Data Highway, RS-232, Interbus, DeviceNet, HART, Ethernet or some other field bus, controller area network, or local area network protocol. A feedback signal can alternatively provide digital information (e.g., whether a predetermined level or density threshold is exceeded) in the form of a discrete ON/OFF voltage signal, and/or in any of a variety of digital formats to accommodate a particular communication protocol such as, for example, Profibus, Data Highway, RS-232, Interbus, DeviceNet, HART, Ethernet or some other field bus, controller area network, or local area network protocol. By monitoring the feedback signal, one can determine the level, density or other characteristic of the fluid monitored by the detector assembly 26.

In response to signals from the scintillation detector 78, the processor unit 88 can additionally or alternatively be configured to drive a display screen 90 which can be disposed within the cabinet cavity 31. The display screen 90 can be electrically coupled with, and mechanically attached to, the processor unit 88, as generally shown in FIGS. 21 and 5. The display screen 90 can be configured to display the level, density or other characteristic of the fluid monitored by the detector assembly 26 (see FIG. 4). In one embodiment, the display screen can comprise a liquid crystal (“LCD”) display, which might or might not be backlit, though it will be appreciated that any of a variety of other types of display screens can alternatively be provided. In another alternative embodiment, a detector assembly might not include a display screen.

An indicator light 92 (FIG. 5) can also be disposed within the cabinet cavity 31 and electrically coupled with at least one of the display screen 90, the processor unit 88, and the junction board 80. The indicator light 92 can be configured to display an operational characteristic of the detector assembly 26. For example, the indicator light 92 can be configured to illuminate when the detector assembly 26 receives operational power. In one embodiment, the indicator light 92 can be configured to flash upon detection of a predetermined fault condition. The indicator light 92 can comprise a light emitting diode (“LED”) or any of a variety of other suitable devices. In an alternative embodiment, a detector assembly can include more than one indicator light, with each indicator light being configured to identify a respective operational characteristic (e.g., power, fault) of the detector assembly. In another alternative embodiment, a detector assembly might not include any such indicator light.

In one embodiment, the lid 34 can be configured to facilitate visibility of the display screen 90 and/or the indicator light 92 from outside the detector assembly 26 when the lid 34 is in a closed position with respect to the base 32. More particularly, with reference to FIGS. 6-7, the lid 34 can define a window aperture 46. A transparent window 44 can be compressed against or adjacent to a portion of the lid 34 defining the window aperture 46, such as by threadably engaging a retention ring 48 with the lid 34 and against or adjacent to the window 44, as generally shown in FIG. 7. The retention ring 48 can include a plurality of indentations 49 to facilitate tightening of the retention ring 48 with respect to the lid 34. It will be appreciated that one or more seals or liquid sealants can be provided to facilitate a sealed interface between the window 44 and the lid 34 when the window 44 is covering the window aperture 46.

The base 32 of the cabinet 30 can define a threaded receptacle 33 which can be configured to threadably receive a proximal end 58 of the elongate structure 50. With reference to FIGS. 8-9, the elongate structure 50 can extend along the longitudinal axis “A” from the proximal end 58 to a distal end 60. More particularly, with reference to FIGS. 1 and 8, the elongate structure 50 can comprise a first annular member 52, a second annular member 54, and a third annular member 56. The first annular member 52 is shown to generally comprise a pipe nipple having male threaded ends 53 and 133. The threaded end 133 can define the proximal end 58 of the elongate structure 50 and can be configured to threadably engage the threaded receptacle 33 in the base 32. The second annular member 54 can generally comprise a pipe coupler having female threaded ends 55 and 57. The threaded end 55 can be configured to threadably engage the threaded end 53 of the first annular member 52. The third annular member 56 can have a male threaded end 59 and a female threaded end 171. The threaded end 59 can be configured to threadably engage the threaded end 57 of the second annular member 54. The threaded end 171 can define the distal end 60 of the elongate structure 50 and can be configured to threadably engage a threaded portion 71 of the end wall 70. A seal member 73 can be provided to facilitate a sealed interface between the end wall 70 and the threaded end 171. The threaded receptacle 33 of the cabinet 30 and the threaded ends 53, 55, 57, 59 and 133 of the respective first, second, and third annular members 52, 54, and 56 can be tapered as generally shown in FIG. 8, or can alternatively be provided as untapered threads with seals (e.g., like the threaded portion 71 of the end wall 70 and the threaded end 171 of the third annular member 56).

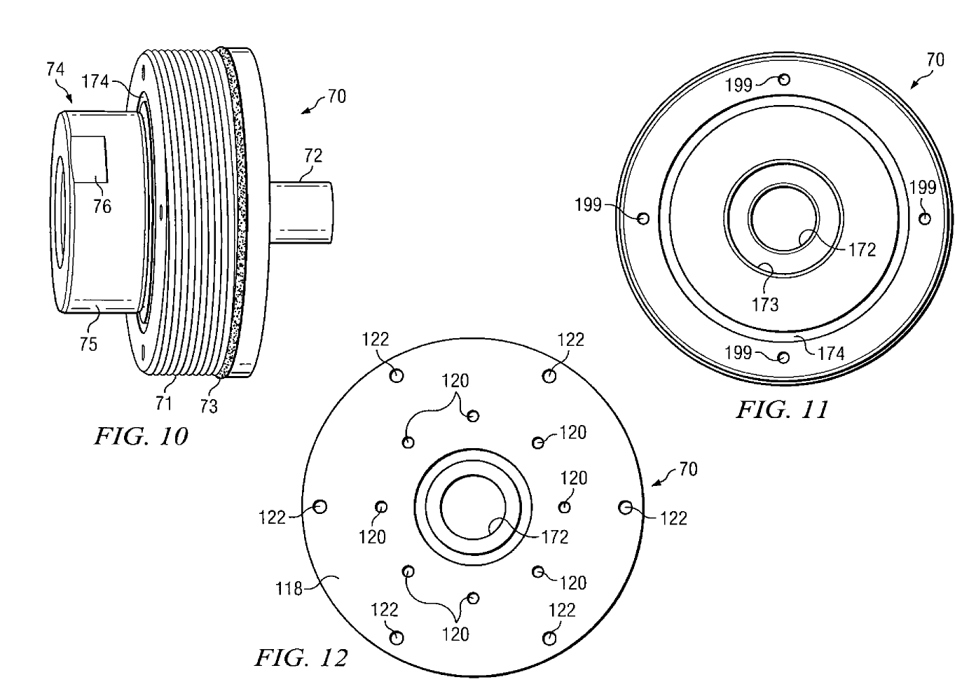

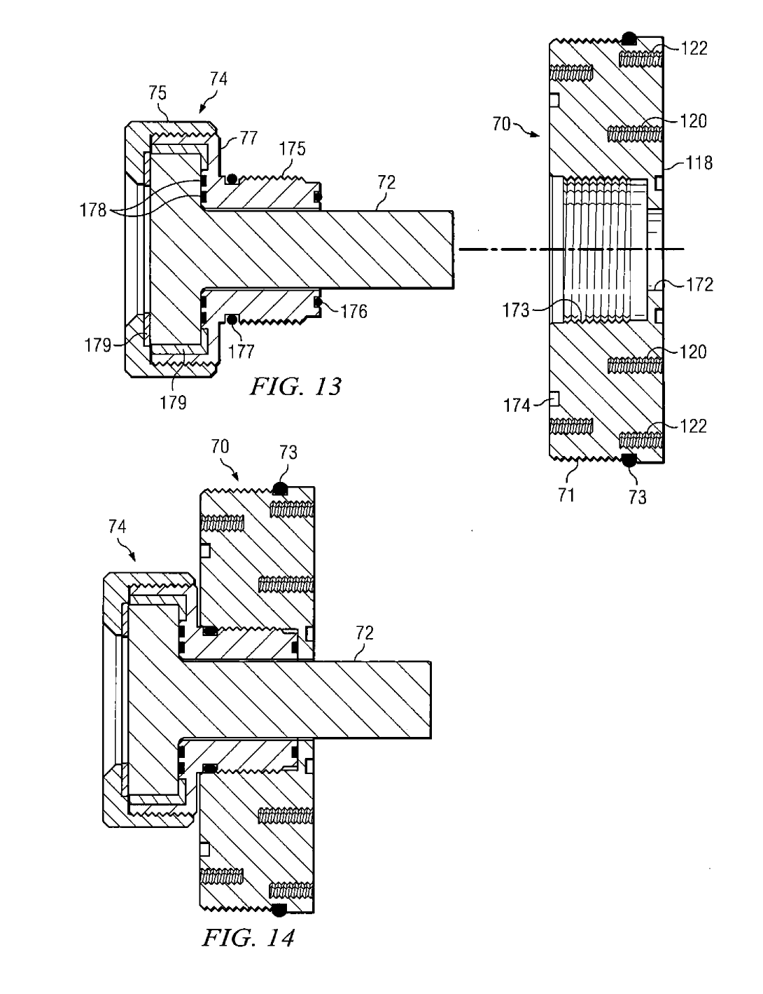

Prior to threadably engaging the end wall 70 with the elongate structure 50, the light pipe 72 can be secured to the end wall 70. More particularly, with reference to FIGS. 10-14, a light pipe retention assembly 74 can include a cap 75, a base 77, and seal members 176, 177 and 178. To assemble the light pipe retention assembly 74 with respect to the light pipe 72, the seal members 178 can be disposed within channels formed within the base 77, and the light pipe 72 can then be seated against the seal members 178. The cap 75 can then be threaded onto a threaded outer surface of the base 77 and tightened to compress the light pipe 72 against the seal members 178 and the base 77, as shown in FIG. 13. Adhesive or liquid sealant 179 can be applied during this process to facilitate a sealed interface between the light pipe 72 and the light pipe retention assembly 74. A threaded shank 175 of the base 77 can then be threaded into a threaded bore 173 in the end wall 70 and tightened. The cap 75 can include one or more notches or flattened surfaces to facilitate tightening of the cap 75 with respect to the base 77, and/or to facilitate tightening of the light pipe retention assembly 74 with respect to the end wall 70. The seal members 176 and 177 can facilitate a sealed interface between the light pipe retention member 74 and the end wall 70. When the light pipe retention assembly 74 is fully tightened with respect to the end wall 70, an end of the light pipe 72 can protrude through an aperture 172 in the end wall 70, as shown in FIG. 14. The light pipe 72 can be formed from polished quartz, fused silica, or glass, for example.

The elongate structure 50 can define a detector cavity 62, as shown in FIG. 9. The detector cavity 62 can have an axial dimension extending along the longitudinal axis “A” and can have a transverse cross-sectional shape which is shown to be generally circular and to have a diametric dimension “D” which can be an inside diameter of the elongate structure 50. In one embodiment, as generally shown with respect to the detector cavity 62, the transverse cross-sectional shape of the detector cavity 62 can be generally circular and uniform along substantially the entire axial dimension of the detector cavity 62. The detector cavity 62 can be in communication with the cabinet cavity 31 such that, for example, the wire harness 101 can extend from the scintillation detector 78 in the detector cavity 62 to the junction board 80 in the cabinet cavity 31.

The transverse cross-sectional shape of the cabinet cavity 31 can be greater than the transverse cross-sectional shape of the detector cavity 62 meaning that, for example, at least one of the height “H” and width “W” of the transverse cross-sectional shape of the cabinet cavity 31 exceeds the diametric dimension “D” of the transverse cross-sectional shape of the detector cavity 62. This increased dimension of the cabinet cavity 31 as compared to the detector cavity 62 can facilitate convenient and efficient provision of components such as the junction board 80 and the processor unit 88 in the cabinet cavity 31, while such provision of those same components in the detector cavity 62 might not be possible or effective. In one embodiment in which the transverse cross-sectional shape of the cabinet cavity 31 is greater than the transverse cross-sectional shape of the detector cavity 62, both the height “H” and the width “W” of the transverse cross-sectional shape of the cabinet cavity 31 exceeds the diametric dimension “D” of the transverse cross-sectional shape of the detector cavity 62. In another embodiment in which the transverse cross-sectional shape of the cabinet cavity 31 is greater than the transverse cross-sectional shape of the detector cavity 62, only one of the height “H” and the width “W” of the transverse cross-sectional shape of the cabinet cavity 31 exceeds the diametric dimension “D” of the transverse cross-sectional shape of the detector cavity 62.

The scintillation detector 78 can be disposed within at least one of the detector cavity 62 and the cabinet cavity 31. For example, as shown in FIG. 9, the scintillation detector 78 can be disposed within the detector cavity 62. As shown in FIGS. 8-9, the scintillation detector 78 can include a generally cylindrical wall structure 93 which can have flanges 69 at one end which are attached to the end wall 70, such as with bolts 99 threadably engaged with threaded apertures 199 in the end wall 70. When so attached, a portion of that end of the wall structure 93 can be received within a channel 174 (FIG. 11) formed in the end wall 70. At the opposite end of the wall structure 93, a connector plate 104 can be attached to the wall structure 93 such as with bolts 106. The connector 102 can be attached to, and supported by, the connector plate 104. In one embodiment, as shown in FIG. 9, a ground wire 108 can be attached to one of the bolts 106 and then routed to the junction board 80. One or more annular spacers (e.g., 100 in FIG. 9) can be provided to prevent radial movement of the wall structure 93 with respect to the elongate structure 50 when the scintillation detector 78 is positioned within the detector cavity 62 as shown in FIG. 9.

The scintillation detector 78 can include various additional components disposed within a cavity 83 defined by the wall structure 93. For example, with reference to FIG. 9, a detector module 84, such as a photodetector or photo multiplier tube, can be supported within the cavity 83 by a socket 112 and one or more spacers (e.g., 110), such that the detector module 84 is in optical communication with the light pipe 72. In one embodiment, a cushion 85 can be provided between the detector module 84 and the light pipe 72, such as to prevent vibration or abrasion of the detector module 84 and/or light pipe 72, and/or to serve as a conditioner of light passing from the light pipe 72 to the detector module 84. The cushion 85 can be formed from a silicone elastomer compound, for example. Additionally, conditioner circuitry 86 can be provided within the cavity 83 and can be provided upon circuit boards (e.g., 87) which can be electrically coupled with the detector module 84 and the connector 102. In one embodiment, the conditioner circuitry 86 can condition and/or amplify power to, and signals from, the detector module 84. The conditioner circuitry 86 can also facilitate transmission of electrical signals from the detector module 84 to the junction board 80 and processor unit 88, as generally shown in FIG. 21. It will be appreciated that a scintillation detector can be provided in any of a variety of other suitable configurations.

When the detector assembly 26 is fully assembled and the lid 34 of the cabinet 30 is closed, such as shown in FIGS. 1-4, the elongate structure 50, the cabinet 30, the end wall 70, and the light pipe 72 can cooperate to at least partially define an explosion-proof housing for the scintillation detector 78, the junction board 80, the processor unit 88, the display screen 90 and the indicator light 92. The detector assembly 26 can be attached to any of a variety of suitable detector units to suit various applications. When a detector unit does not include any electrical components, the detector unit need not itself be provided within an explosion-proof housing in order for a detector system including the detector unit to have an explosion-proof rating, provided that the detector assembly of the detector system has an explosion-proof housing or rating. By avoiding any need for a detector unit to have an explosion-proof housing or rating, it will be appreciated that the outer wall thickness and/or strength of the detector unit can be significantly reduced, thus resulting in a smaller, lighter weight, easier to manufacture, and/or less expensive detector unit and detector system.

In order to facilitate attachment of the detector assembly 26 to any of a variety of suitable detector units, the end wall 70 can include a plurality of apertures. For example, the end wall 70 is shown in FIGS. 12-14 to include an end surface 118 through which multiple sets of threaded apertures (e.g., 120, 122) can extend. Through abutment with the end surface 118, optical coupling with the light pipe 72, and attachment to the end wall 70 with bolts into one or more of the apertures 120 and 122, a detector unit can be attached to the detector assembly 26. For example, as described below, each of the end wall 70 and the light pipe 72 can be configured to be selectively, alternatively and removably coupled with a rigid crystal-type detection unit 210 and a flexible fluid-type detection unit 310. More particularly, the threaded apertures 120 and 122 can be configured to receive bolts (e.g., 220, 222, 320) to facilitate selective and alternative coupling of the rigid crystal-type detection unit 210 and the flexible fluid-type detection unit 310 with the end wall 70.

FIG. 15 illustrates a detector system 208 including the rigid crystal-type detection unit 210 attached to the detector assembly 26. The rigid crystal-type detection unit 210 is shown to comprise a protective sheath 212 which extends from a first end 213 to a second end 214. An end plate 218 can seal the distal end 214 of the protective sheath 212 and can, for example, be welded to the protective sheath 212. A mounting flange 216 can be attached to the first end 213 of the protective sheath 212.

In order to facilitate removable fastening of the rigid crystal-type detection unit 210 to the detector assembly 26, bolts 220 can pass through unthreaded apertures in a mounting flange 221 and into the threaded apertures 120 in the end wall 70, and bolts 222 can pass through unthreaded apertures in the mounting flange 216 and into the threaded apertures 122 in the end wall 70. The mounting flange 221 can be disposed within a sheath cavity 219 defined by the protective sheath 212 and can be configured to receive an end of a rigid crystal 215, as generally shown in FIG. 15. The sheath cavity 219 and rigid crystal 215 can extend coaxially along the longitudinal axis “A”, with the rigid crystal 215 disposed within the sheath cavity 219. One or more annular spacers (e.g., 217) can be provided to prevent radial movement of the rigid crystal 215 with respect to the protective sheath 212. When the rigid crystal-type detection unit 210 is attached to the detector assembly 26, the rigid crystal 215 can be provided in optical communication with the light pipe 72, as generally shown in FIG. 15. In one embodiment, a cushion 224 can be provided between the rigid crystal 215 and the light pipe 72, such as to prevent vibration or abrasion of the rigid crystal 215 and/or light pipe 72, and/or to serve as a conditioner of light passing from the rigid crystal 215 to the light pipe 72. The cushion 224 can be formed from a silicone elastomer compound, for example.

The elongate structure 50 and the protective sheath 212 can each be configured for direct exposure to environmental conditions in use of the detector system 208 and can extend along entirely distinct portions of the longitudinal axis “A”, as shown in FIG. 15. The end wall 70 can facilitate attachment of the protective sheath 212 with respect to the elongate structure 50, and can function to separate the detector cavity 62 from the sheath cavity 219. However, the elongate structure 50 and the protective sheath 212 can be separable from one another. Because the rigid crystal-type detection unit 210 need not itself have an explosion-proof rating, a wall thickness “t” of the protective sheath 212 can be substantially less than a wall thickness of any of the members of the elongate structure 50 such as, for example, wall thickness “T” (FIG. 9) of the first and third annular members 52 and 56 of the elongate structure 50. For example, the wall thickness “T” can be at least twice as large as the wall thickness “t”.

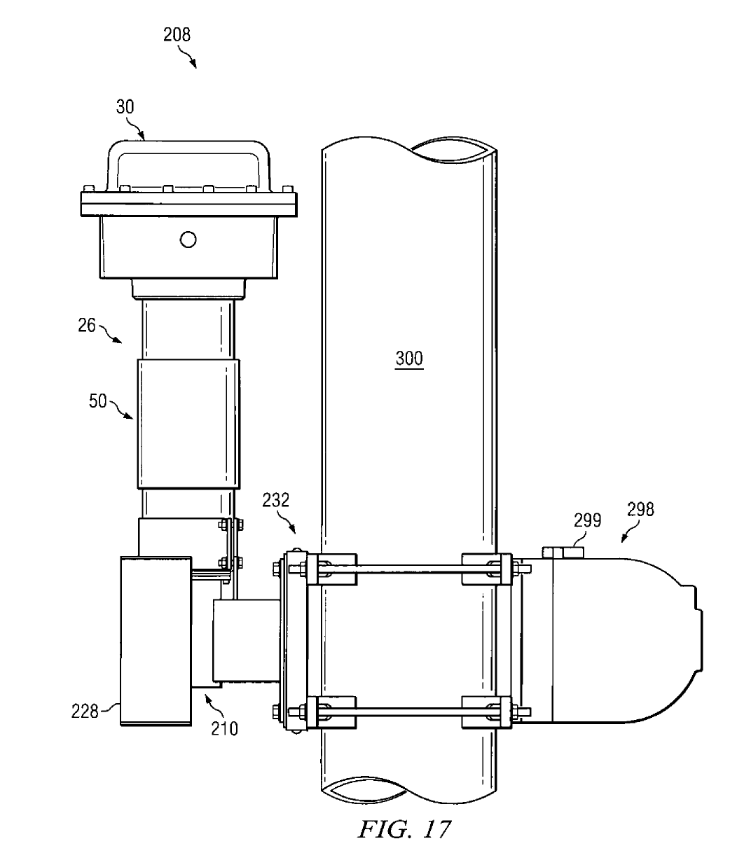

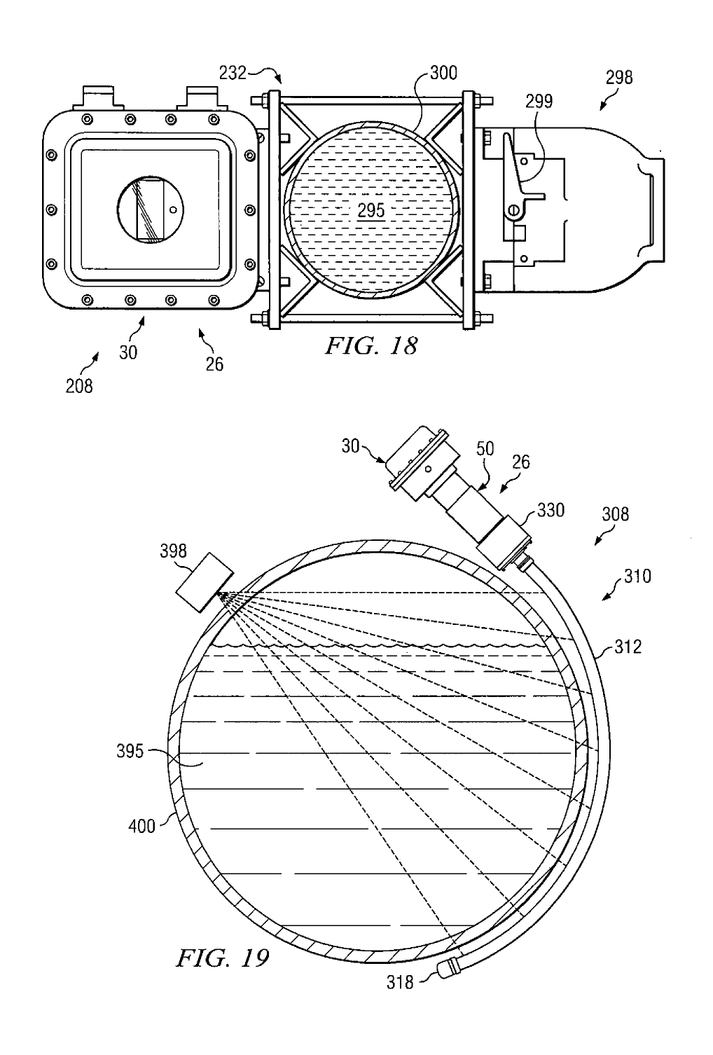

FIGS. 17-18 illustrate an example of an application of the detector system 208 of FIG. 15 (though in the example of FIGS. 17-18, the rigid crystal-type detection unit 210 is shown to have a shorter longitudinal length than in FIG. 15). In particular, the detector system 208 is shown in FIGS. 17-18 to be provided for use in monitoring fluid 295 passing through a pipe 300. In this application, a bracket assembly 232 is shown to support the detector system 208 on one side of the pipe 300, while also supporting a radiation source 298 on an opposite side of the pipe 300. In one embodiment, the radiation source 298 can comprise Cesium¹³⁷. The radiation source 298 is shown to have a shutter 299 which can be selectively opened to facilitate passage of gamma energy from the radiation source 298 and through the pipe 300 and fluid 295, and then into the rigid crystal-type detection unit 210 of the detector system 208. A shield 228 can be associated with the detector system 208 to help prevent undesirable proliferation of gamma energy beyond the detector system 208. When the shutter 299 is closed, gamma energy can be prevented from being emitted from the radiation source 298, such as during times when operation of the detector system 208 is not desired. It will be appreciated that a detector system having a rigid crystal-type detection unit can be provided in any of a variety of alternative applications. For example, it will be appreciated that a rigid crystal-type detection unit can be provided in lengths many feet or meters long such as to facilitate monitoring of fluid within tanks.

In certain applications, it might be desirable to employ a detection unit which is bendable, such as to facilitate monitoring of fluids within round tanks as shown in FIG. 19. For example, FIG. 16 illustrates the flexible fluid-type detection unit 310 attached to the detector assembly 26. The flexible fluid-type detection unit 310 is shown to comprise a reservoir assembly 330 which is removably fastened to the end wall 70 with bolts 320 which pass through unthreaded apertures in the reservoir assembly 330 and into the threaded apertures 120 in the end wall 70. A first end of a flexible tube assembly 312 is shown to be coupled with the reservoir assembly 330 and the light pipe 72. A second end of the flexible tube assembly 312 is shown to terminate at an end cap 318. The flexible tube assembly 312 is shown to comprise an outer tube 324 and an inner tube 325. The outer tube 324 can serve to protect the inner tube 325 from damage. A scintillation fluid 315 can fill the inner tube 325 and at least a portion of the reservoir assembly 330. It will be appreciated that the flexible tube assembly 312 can include seals to prevent undesired leakage of scintillation fluid 315 and/or environmental contamination of the scintillation fluid 315.

Through use of gravity, the reservoir assembly 330 can maintain a full level of scintillation fluid 315 within the inner tube 325 at all times, regardless of normal temperature fluctuations. The light pipe 72 can be optically coupled with the scintillation fluid 315 such that scintillations of light within the scintillation fluid 315 can be transmitted through the light pipe 72 and into the scintillation detector 78 of the detector assembly 26. Clamps 326 can be provided along the length of the flexible tube assembly 312 to facilitate securement of the flexible tube assembly 312 to a tank or other structure. U.S. Pat. No. 7,132,662 B2 and U.S. Patent Application Publication No. 2006/0138330 A1 are hereby incorporated herein by reference in their entirety, and disclose materials and assembly techniques as may be helpful in constructing the flexible fluid-type detection unit 310, as well as information regarding scintillation detection in general.

FIG. 19 illustrates an example of an application of the detector system 308 of FIG. 16. In particular, the detector system 308 is shown in FIG. 19 to be provided for use in monitoring fluid 395 within a tank 400. A radiation source 398 (e.g., Cesium¹³⁷) is shown to emit gamma energy through the tank 400 and then into the flexible fluid-type detection unit 310 of the detector assembly 308. Although not shown, it will be appreciated that the radiation source 398 can be provided with a shutter, such as described above with respect to the radiation source 298. One or more shields can also be provided to facilitate undesired proliferation of gamma energy beyond the detector assembly 308. It will also be appreciated that one or more clamps (e.g., like 326 in FIG. 16) and/or brackets (not shown) can be provided to facilitate attachment of the detector assembly 308 to the tank 400. It will further be appreciated that a detector system having a flexible fluid-type detection unit can be provided in any of a variety of alternative applications.

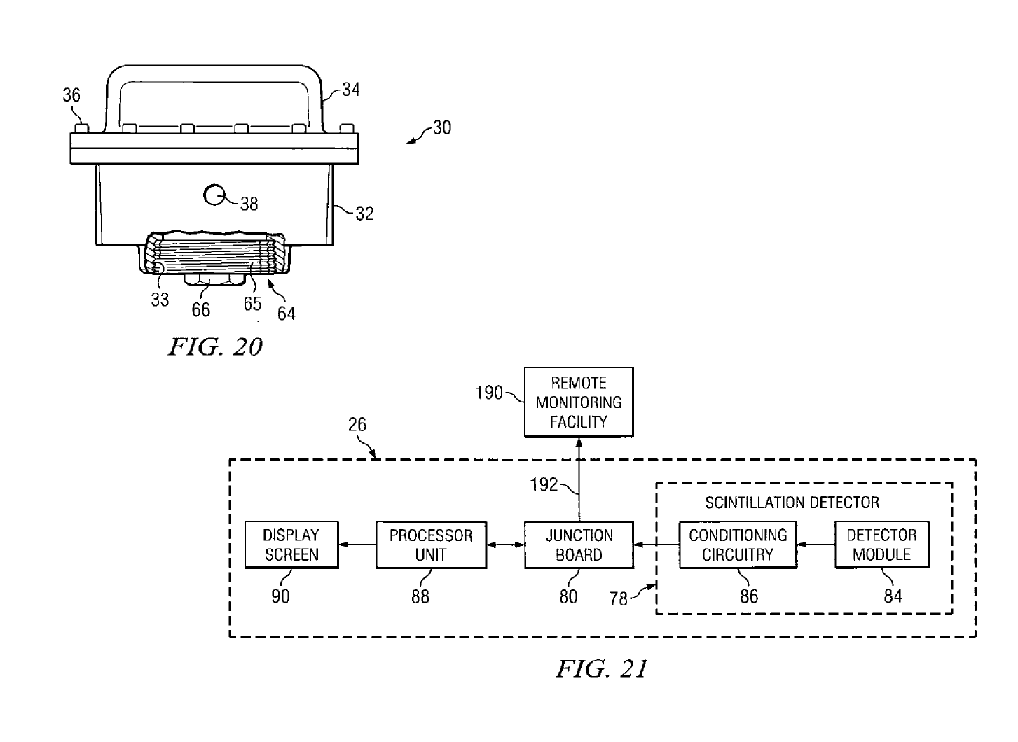

It will be appreciated that the components of the detector assembly 26 can provide for still further modularity. For example, it will be appreciated that the cabinet 30 can be used apart from the elongate structure 50, and can in fact be mounted remotely from a scintillation detector and electrically coupled with the scintillation detector with wiring through a conduit, for example. When in this configuration, any of a variety of components can be disposed within the cabinet cavity 31 such as, for example, the junction board 80, the processor unit 88, the display screen 90, and the indicator light 92. Field wiring can also be received into the cabinet cavity 31. When mounting the cabinet 30 apart from the elongate structure 50, a threaded portion 65 of a pipe plug 64 can be received within the threaded receptacle 33 in the base 32 of the cabinet 30, as shown in FIG. 20, thereby sealing the cabinet 30 and facilitating an explosion-proof rating. The pipe plug 64 is shown to include a plurality of abutment faces (e.g., 66) to facilitate grasping and tightening or loosening of the pipe plug 64 with a wrench. In another alternative embodiment, a detector assembly might include a cabinet (like cabinet 30), but there might not be any junction board, processor unit, display screen or indicator light provided within the cabinet, but rather the cabinet might simply be used as a junction box for connection of wiring from a remote processor to a wiring harness from a scintillation detector of the detector assembly. It will be appreciated that, if the cabinet 30 is removed from the threaded end 133 of the elongate structure 50, a cap (not shown) can be placed upon the threaded end 133, and the cap can include a port to facilitate connection of wiring from a remote processor to a wire harness for the scintillation detector 78.

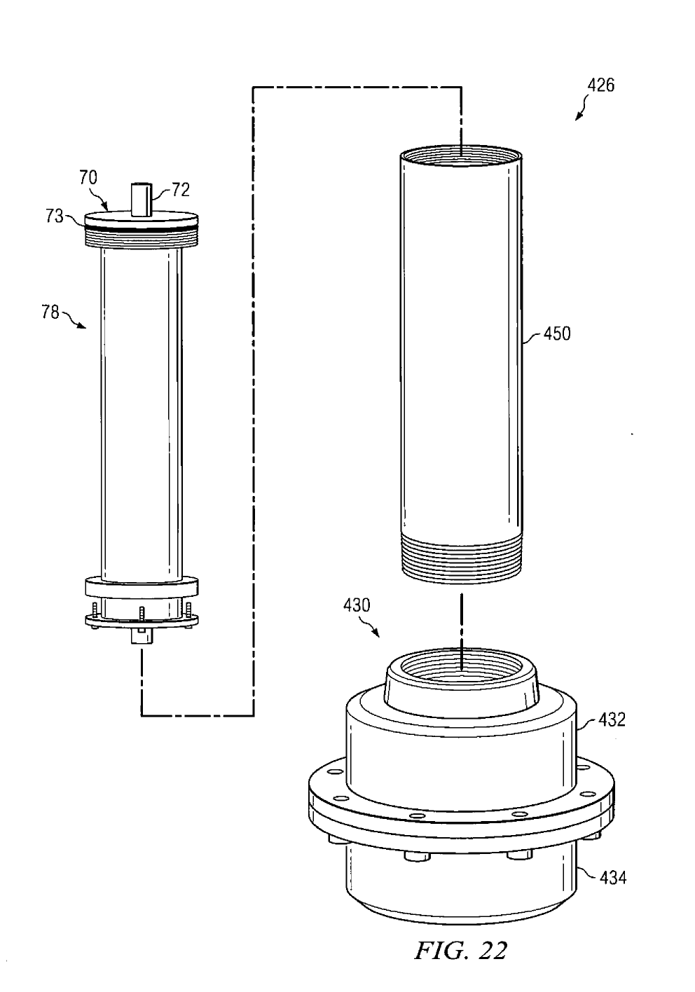

A detector assembly can be provided in any of a variety of alternative configurations. For example, with reference to FIG. 22, an alternative detector assembly 426 can include a cabinet 430 having a generally round transverse shape, and/or wherein a lid 434 of the cabinet 430 is not hingedly coupled with a base 432 of the cabinet 430. Also, as shown in FIG. 22, instead of providing the elongate structure 50 in three separate components (i.e., first, second, and third annular members 52, 54, and 56) which are attached together as described with respect to the detector assembly 26, the detector assembly 426 can include an elongate structure 450 which is provided as a single unitary component. In other respects, the detector assembly 426 can be generally similar to the detector assembly 26 described above.

In one embodiment, one or more of the cabinet 30, the elongate structure 50, the end wall 70, and certain other portions of the detector assembly 26 can be formed from aluminum. In another embodiment, one or more of the cabinet 30, the elongate structure 50, the end wall 70, and certain other portions of the detector assembly 26 can be formed from steel or some other metal or alloy or other material or combination thereof. The material can be selected for suitability with expected environmental conditions and exposures of the detector assembly 26 (e.g., for corrosion and/or abrasion resistance), to provide the detector assembly 26 with an explosion-proof rating, and/or to optimize weight and cost of the detector assembly 26. In still other embodiments, other features of a detector assembly can be provided in any of a variety of suitable differing configurations, and may or may not be explosion-proof.

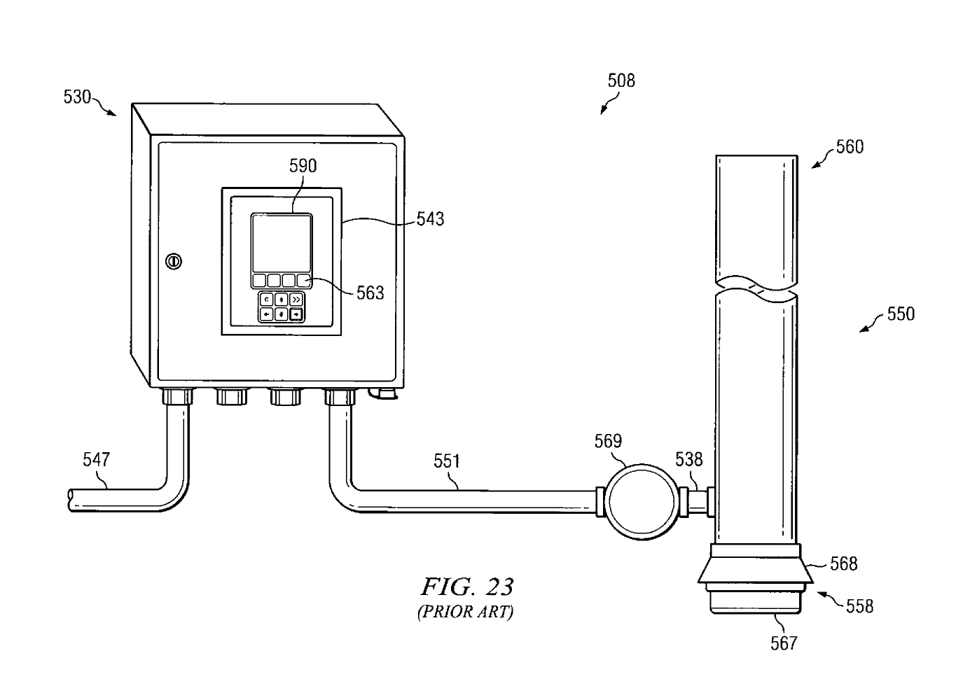

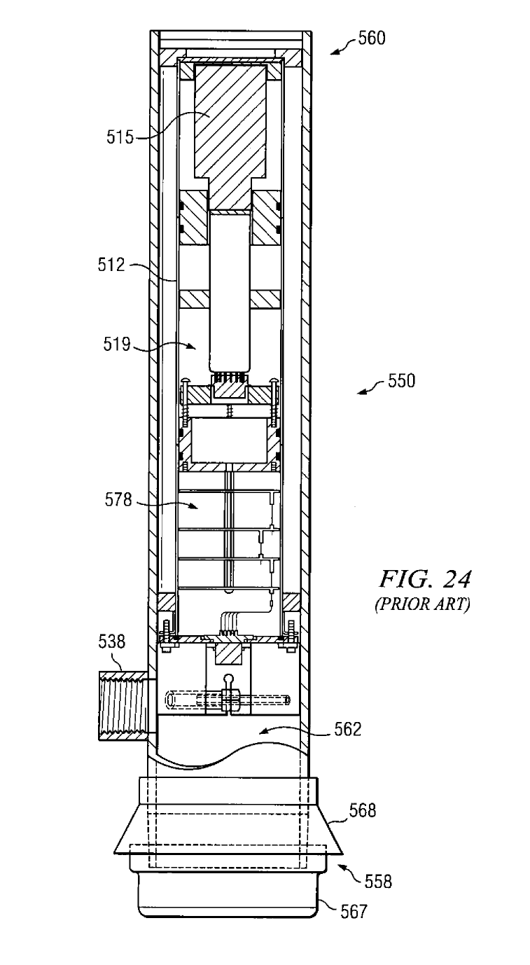

FIG. 23 depicts a conventional detector system 508 having an elongated housing 550. The housing 550 is welded shut at a distal end 560 and threadably receives a cap 567 at a proximal end 558. A rain guard 568 is slid over the housing 550 adjacent to the proximal end 558 to help deflect falling moisture from contacting the threaded interface between the housing 550 and the cap 567. The housing 550 defines a threaded outlet port 538 to which a junction box 569 is coupled. A conduit 551 couples the junction box 569 with a remotely-mounted wall cabinet 530. The wall cabinet 530 houses an interface unit 543 which incorporates a display screen 590 and a plurality of pushbuttons (e.g., 563). A processor unit (not shown) is also housed within the wall cabinet 530 and is electrically coupled with the interface unit 543. Through use of wiring (not shown) run through the conduit 551 and the junction box 569, the processor unit is also electrically coupled with a scintillation detector (578 in FIG. 24) within the housing 550. The display screen 590 is configured to display information relating to fluid level or density in response to signals the processor unit receives from the scintillation detector 578. In further response to these signals, the processor unit transmits feedback signals to a remote monitoring unit through use of wires passing through a conduit 547 attached to the wall cabinet 530.

The scintillation detector 578 is shown in FIG. 24 to be optically coupled with a rigid crystal 515. A protective sheath 512 is generally cylindrical and defines a sheath cavity 519. The rigid crystal 515 and the electronic components of the scintillation detector 78 are shown to be disposed within the sheath cavity 519. The protective sheath 512 is disposed within a cavity 562 defined by the housing 550. Other features of the conventional detector system 508 are illustrated in FIGS. 23-24 and will be appreciated in light of the foregoing and the illustrations themselves.

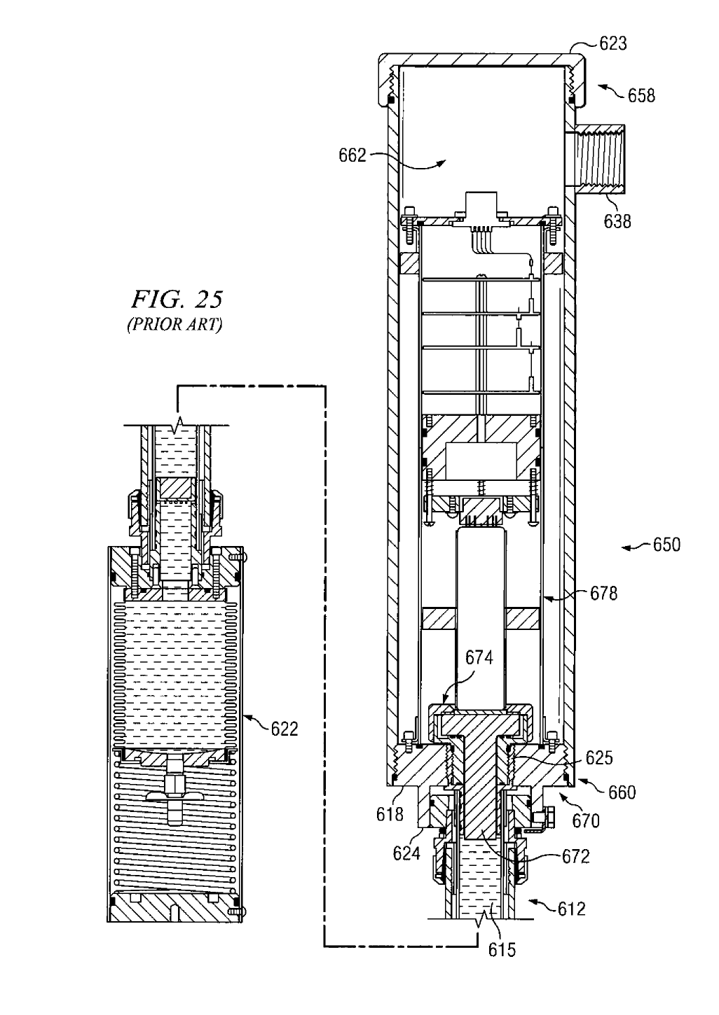

FIG. 25 depicts a portion of another conventional detector system in which an elongate structure 650 extends between a proximal end 658 and a distal end 660. The detector assembly 626 further includes a cap 623, an end wall 670, and a light pipe 672. The cap 623 is threadably engaged with the proximal end 658 of the elongate structure 650. The end wall 670 is threadably engaged with the distal end 660 of the elongate structure 650. A scintillation detector 678 is disposed within a detector cavity 662 defined by the elongate structure 650, and is configured similarly to the scintillation detector 78 described above, as can be seen in FIG. 25. The scintillation detector 678 is in optical communication with the light pipe 672, which in turn is in optical communication with scintillation fluid 615 disposed within a flexible tube assembly 612. The housing 650 defines a threaded outlet port 638 to which a junction box (not shown) is attached to facilitate wiring of the scintillation unit 678 to a processor unit (not shown) within a wall cabinet (similar to 530 in FIG. 23).

The end wall 670 defines a threaded aperture which receives a stepped annular collar 625. A light pipe retention assembly 674 supports the light pipe 672 and is threadably received within a threaded aperture defined in the stepped annular collar 625, as also shown in FIG. 25. The end wall 670 defines an annular projection 624 extending forward of an end surface 618 of the end wall 670. The stepped annular collar 625 and the annular projection 624 cooperate with other components to facilitate attachment of the flexible tube assembly 612 to the end wall 670. On an opposite end of the flexible tube assembly 612, a spring-loaded damper 622 is provided, such as discussed in U.S. Pat. No. 7,132,662 B2 and U.S. Patent Application Publication No. 2006/0138330 A1.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A detector assembly comprising:
an elongate structure having a proximal end and a distal end and defining a detector cavity, the detector cavity having an axial dimension extending along a longitudinal axis, and the detector cavity having a first transverse cross-sectional shape;
a cabinet attached to the proximal end of the elongate structure, the cabinet defining a cabinet cavity in communication with the detector cavity, the cabinet cavity extending along the longitudinal axis and having a second transverse cross-sectional shape greater than the first transverse cross-sectional shape;
a scintillation detector disposed within at least one of the detector cavity and the cabinet cavity; and
a wire harness coupled with the scintillation detector and extending into the cabinet cavity.

2. The detector assembly of claim 1 wherein the first transverse cross-sectional shape is circular and has a diametric dimension, and wherein the second transverse cross-sectional shape has a transverse dimension exceeding the diametric dimension.

3. The detector assembly of claim 2 wherein the second transverse cross-sectional shape is generally rectangular.

4. The detector assembly of claim 1 further comprising an end wall and a light pipe, wherein the end wall is attached to the distal end of the elongate structure, the end wall defines an aperture extending through the end wall, and the light pipe extends into the aperture in the end wall and is in optical communication with the scintillation detector.

5. The detector assembly of claim 4 wherein:
the elongate structure comprises a first annular member, a second annular member, and a third annular member;
each of the first annular member and the third annular member threadably engages the second annular member;
the first annular member defines the proximal end of the elongate structure;
the third annular member defines the distal end of the elongate structure;
the base of the cabinet defines a threaded receptacle;
the first annular member threadably engages the threaded receptacle in the base; and
the third annular member threadably engages the end wall.

6. The detector assembly of claim 4 wherein the elongate structure, the cabinet, the end wall, and the light pipe cooperate to at least partially define an explosion-proof housing for at least the scintillation detector.

7. The detector assembly of claim 4 wherein each of the end wall and the light pipe are configured to be selectively and alternatively coupled with a rigid crystal-type detection unit and a flexible fluid-type detection unit.

8. The detector assembly of claim 1 wherein the cabinet comprises a base, a lid, and a plurality of fasteners, and wherein the plurality of fasteners are configured to selectively secure the base to the lid in a closed position such that the base and the lid cooperate to define the cabinet cavity.

9. The detector assembly of claim 8 wherein the lid is hingedly coupled with the base.

10. The detector assembly of claim 8 wherein:
one of the lid and the base defines a plurality of threaded apertures;
the other of the lid and the base defines a plurality of unthreaded apertures; and
each of the fasteners comprises a bolt which extends:
through a respective one of the unthreaded apertures in the one of the lid and the base; and
into a respective one of the threaded apertures in the other of the lid and the base.

11. The detector assembly of claim 1 further comprising a processor unit electrically coupled with the wire harness, the processor unit disposed within the cabinet cavity.

12. The detector assembly of claim 11 further comprising a display screen, wherein:
the cabinet comprises a window and defines a window aperture;
the window covers the window aperture; and
the display screen is electrically coupled with the processor unit, is disposed within the cabinet cavity, and is visible from outside the cabinet cavity through the window.

13. The detector assembly of claim 11 further comprising a junction board disposed within the cabinet cavity, electrically coupled with the processor unit, and configured for electrical coupling with field wiring.

14. The detector assembly of claim 11 wherein the processor unit is configured to generate a feedback signal in response to signals received by the processor unit from the scintillation detector through the wire harness, and wherein the feedback signal is configured for transmission over an extended distance to a remote monitoring facility.

15. A detector system comprising:
a detector assembly comprising:
an elongate structure having a proximal end and a distal end and defining a detector cavity, the detector cavity having an axial dimension extending along a longitudinal axis;
a scintillation detector disposed at least partially within the detector cavity;
an end wall attached to the distal end of the elongate structure, the end wall defining an aperture extending through the end wall; and
a light pipe extending into the aperture in the end wall and in optical communication with the scintillation detector; and
a rigid crystal-type detection unit separable from the detector assembly, the rigid crystal-type detection unit comprising:
a protective sheath having a first end and a second end and defining a sheath cavity extending along the longitudinal axis;
a rigid crystal extending along the longitudinal axis and disposed within the sheath cavity;
wherein:
the first end of the protective sheath is removably fastened to the end wall; and
the rigid crystal is in optical communication with the light pipe.

16. The detector assembly of claim 15 wherein the elongate structure and the end wall cooperate to at least partially define an explosion-proof housing for at least the scintillation detector.

17. The detector system of claim 15 wherein the elongate structure and the protective sheath are separable from one another, and extend along entirely distinct portions of the longitudinal axis.

18. The detector system of claim 15 wherein the detector cavity is separated from the sheath cavity by the end wall.

19. The detector system of claim 15 wherein the elongate structure has a first wall thickness, the protective sheath has a second wall thickness, and the first wall thickness is at least twice as large as the second wall thickness.

20. The detector system of claim 15 further comprising:
a cabinet attached to the proximal end of the elongate structure and defining a cabinet cavity in communication with the detector cavity;
a wire harness; and
at least one of a processor unit and a display screen disposed within the cabinet cavity and electrically coupled with the scintillation detector through use of the wire harness.

21. The detector system of claim 20 wherein:
the elongate structure comprises a first annular member, a second annular member, and a third annular member;
each of the first annular member and the third annular member threadably engages the second annular member;
the first annular member defines the proximal end of the elongate structure;
the third annular member defines the distal end of the elongate structure;
the base of the cabinet defines a threaded receptacle;
the first annular member threadably engages the threaded receptacle in the base; and
the third annular member threadably engages the end wall.

22. The detector system of claim 20 wherein the elongate structure, the cabinet, the end wall, and the light pipe cooperate to at least partially define an explosion-proof housing for at least the scintillation detector.

23. A detector assembly comprising:
an elongate structure having a proximal end and a distal end and defining a detector cavity;
a scintillation detector disposed at least partially within the detector cavity;
an end wall attached to the distal end of the elongate structure, the end wall defining an aperture extending through the end wall; and
a light pipe extending into the aperture in the end wall and in optical communication with the scintillation detector; and
wherein each of the end wall and the light pipe are configured to selectively and alternatively couple with a rigid crystal-type detection unit and a flexible fluid-type detection unit.

24. The detector assembly of claim 23 wherein:
the end wall comprises an outer surface and further defines a plurality of threaded apertures extending through the outer surface; and
the threaded apertures are configured to receive bolts to facilitate selective and alternative coupling of a rigid crystal-type detection unit and a flexible fluid-type detection unit with the end wall.

25. The detector assembly of claim 23 wherein the elongate structure, the end wall, and the light pipe cooperate to at least partially define an explosion-proof housing for at least the scintillation detector.
